(19) United States
(12) Patent Application Publication
(10) Pub. No.: US 2022/0027850 A1
(43) Pub. Date: Jan. 27, 2022

(54) SYSTEMS AND METHODS FOR MANAGING ELECTRONIC BILLS OF LADING VIA SPLIT SCREEN

(71) Applicant: KBX Technology Solutions, LLC, Green Bay, WI (US)

(72) Inventors: John Thomas Hiller, DePere, WI (US); James Patrick Kicher, Denmark, WI (US); James Patrick DePrey, Gillett, WI (US); Tracy Lei Reiss, DePere, WI (US)

(21) Appl. No.: 17/383,827

(22) Filed: Jul. 23, 2021

Related U.S. Application Data
(60) Provisional application No. 63/056,788, filed on Jul. 27, 2020.

(51) Int. Cl. G06Q 10/08; G06F 16/955; G06F 3/0482; G06F 3/0488

(52) U.S. Cl. CPC G06Q 10/0875; G06Q 10/083; G06F 3/04886; G06F 3/0482; G06F 16/9558

(57) ABSTRACT

Systems and methods are configured to provide and manage an electronic bill of lading (eBOL) for a shipment of goods. Various embodiments involve generating an eBOL upon receiving a request from a stakeholder in the shipment of goods. Here, the eBOL is generated from information stored in centralized storage media and is configured as a split screen that includes an interactive panel having fields to enter information and a panel that includes a formal version of the eBOL. The eBOL is displayed on a webpage, browser, interface accessible by the stakeholder so that the stakeholder can enter the information for the fields. Upon doing so, the information stored in the centralized storage media is updated to reflect the information entered by the stakeholder and any subsequent requests from other stakeholders in the shipment of the goods results in displaying the eBOL with the information entered by the stakeholder.

### CROSS-REFERENCE TO RELATED APPLICATIONS

This application claims priority to U.S. Provisional Application No. 63/056,788 filed Jul. 27, 2020, which is hereby incorporated herein in its entirety by reference.

### TECHNOLOGICAL FIELD

Embodiments of the present invention generally relate to systems and methods for issuing and managing electronic bills of lading for shipments of goods.

### BACKGROUND

A bill of lading (BOL) is a document issued by a carrier to acknowledge receipt of a shipment. In general, a BOL acts as a receipt for the goods being shipped describing their apparent condition, quantity, and any other distinctive numbers or marks, and serves as a document of title to the goods that is generally transferable by endorsement. A consignor is the entity who delivers the goods (consignment) to a carrier for transporting from one place to another and ownership of the goods generally remains with the consignor until the consignee (buyer of the goods) pays for them in full. The carrier is the entity that undertakes the professional conveyance of the goods to the consignee.

Accordingly, the BOL serves as a receipt acknowledging the goods have been accepted for transport by the carrier. This receipt can be used by the consignee as proof of shipment for customs and insurance purposes, as well as commercial proof of completing a contractual obligation. In addition, the BOL evidences the terms of the contract of carriage. Here, the seller of the goods can use the BOL to ensure the goods have been properly shipped. If the consignor does not deliver the goods to the carrier in an acceptable manner, then the carrier will not deliver the BOL to the consignee. Often, the BOL is required to be delivered from the consignee to the seller as “proof” of delivery of the goods to the carrier, and the seller can then use the BOL as a contract of carriage between itself and the carrier. Finally, the BOL can serve as a document of title to the goods confirming the buyer is entitled to receive the goods from the carrier.

The conventional practice for BOLs is that a BOL is typically conveyed as a paper document among the various stakeholders (sellers, consignors, consignees, carriers, and buyers). However, the practice of using paper BOLs can lead to difficulties, costs, and inefficiencies. For instance, fifteen percent of transportation costs have been attributed to paperwork, documentation, and administration. These costs can be further increased by bad timing and poor quality in document transfer through clearance delays, letters of indemnity, and detention and demurrage fees. Thus, the industry has sought a solution for many years to these difficulties, costs, and inefficiencies associated with paper BOLs. One such solution has been the digitization of BOLs.

However, although the industry has embraced digitization, complexities still surround the alignment of the stakeholders in the BOL transfer process. For instance, carriers have made use of web BOLE that can be printed from the carriers' website. However, such a capability simply serves as a remote print function and still results in the generation of paper documents that lead to courier and handling costs and expose parties to delay, loss, and fraud risks. It has never been easier for hackers to forge paper documents and fraud and security breaches are an endemic and a critical issue in shipping. Any paper generation and handling of BOLs can become costly and a weak point for an organization, even when the use of digitization is incorporated into the process.

Thus, a need exists in the industry for better utilization of digitization of BOLs. More specifically, a need exists in the industry for better utilization of digitization of BOLs to ensure better end-to-end digital experiences for stakeholders, as well as provide secured digital BOLs. It is with respect to these considerations and others that the disclosure herein is presented.

### BRIEF SUMMARY

In general, embodiments of the present invention provide methods, apparatus, systems, computing devices, computing entities, and/or the like for providing and managing an electronic bill of lading (eBOL) for a shipment of goods. Various embodiments involve generating an eBOL upon receiving a request from a stakeholder in the shipment of goods. For instance, the request may have been generated as a result of the stakeholder activating a hyperlink found in an email.

Here, in particular embodiments, the eBOL is generated from information stored in centralized storage media. The eBOL is configured in various embodiments as a split screen that includes an interactive panel having a plurality of fields to enter information and a panel that includes a formal version of the eBOL. In particular embodiments, at least one of the plurality of fields provided on the interactive panel is specific to the stakeholder who has requested to view the eBOL.

Accordingly, the eBOL is displayed on a webpage, browser, interface accessible by the stakeholder so that the stakeholder can view the eBOL. The stakeholder may enter information for at least one of the plurality of fields and upon doing so, the information stored in the centralized storage media is updated to reflect the information entered by the stakeholder. In addition, the display panel that includes the formal version of the eBOL is updated to display the information entered by the stakeholder. Here, in various embodiments, any subsequent requests from other stakeholders in the shipment of the goods results in displaying the eBOL with the information entered by the stakeholder.

In accordance with one aspect, a method for method for providing and managing an electronic bill of lading (eBOL) for a shipment of goods is provided. In one embodiment, the method comprises, responsive to receiving a request originating from a stakeholder computing entity associated with the shipment of goods, generating, by one or more processors, the eBOL from information stored in centralized storage media, wherein (a) the eBOL is configured for display as a split screen of a webpage, (b) the split screen of the webpage comprises an interactive panel with a plurality of fields into which information can be input, (c) the split screen of the webpage comprises a display panel with a formal version of the eBOL in which the eBOL is displayed, and (d) the interactive panel and the display panel are non-overlapping panels of the webpage; and responsive to receiving input into a field of the plurality of fields, updating the information stored in the centralized storage media to reflect the information entered by the stakeholder, wherein the display panel comprising the formal version of the eBOL is updated to display the input entered in the field of the plurality of fields.

In accordance with another aspect, a computer program product for providing and managing an electronic bill of lading (eBOL) for a shipment of goods is provided. The computer program product may comprise at least one computer-readable storage medium having computer-readable program code portions stored therein, the computer-readable program code portions comprising executable portions configured to, responsive to receiving a request originating from a stakeholder computing entity associated with the shipment of goods, generate the eBOL from information stored in centralized storage media, wherein (a) the eBOL is configured for display as a split screen of a webpage, (b) the split screen of the webpage comprises an interactive panel with a plurality of fields into which information can be input, (c) the split screen of the webpage comprises a display panel with a formal version of the eBOL in which the eBOL is displayed, and (d) the interactive panel and the display panel are non-overlapping panels of the webpage; and responsive to receiving input into a field of the plurality of fields, update the information stored in the centralized storage media to reflect the information entered by the stakeholder, wherein the display panel comprising the formal version of the eBOL is updated to display the input entered in the field of the plurality of fields.

In accordance with yet another aspect, an apparatus comprising at least one processor and at least one memory including computer program code is provided. In one embodiment, the at least one memory and the computer program code may be configured to, with the processor, cause the apparatus to, responsive to receiving a request originating from a stakeholder computing entity associated with the shipment of goods, generate the eBOL from information stored in centralized storage media, wherein (a) the eBOL is configured for display as a split screen of a webpage, (b) the split screen of the webpage comprises an interactive panel with a plurality of fields into which information can be input, (c) the split screen of the webpage comprises a display panel with a formal version of the eBOL in which the eBOL is displayed, and (d) the interactive panel and the display panel are non-overlapping panels of the webpage; and responsive to receiving input into a field of the plurality of fields, update the information stored in the centralized storage media to reflect the information entered by the stakeholder, wherein the display panel comprising the formal version of the eBOL is updated to display the input entered in the field of the plurality of fields.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram of a system architecture that can be used in conjunction with various embodiments of the present invention;

FIG. 2 is a schematic of a computing entity in accordance with various embodiments of the present invention;

FIG. 3 is a process flow for displaying an eBOL in accordance with various embodiments of the present invention;

FIG. 4 is a process flow for generating an eBOL in accordance with various embodiments of the present invention;

FIG. 5 is a process flow for recording information entered by a stakeholder for an eBOL in accordance with various embodiments of the present invention;

FIG. 6 is a configuration for a split screen eBOL with shipper entries in accordance with various embodiments of the present invention;

FIG. 7 is a configuration for a split screen eBOL with shipper entries filled in in accordance with various embodiments of the present invention;

FIG. 8 is a configuration of a display panel with a pdf of an eBOL in accordance with various embodiment of the present invention;

FIG. 9 is a configuration for a split screen eBOL with consignee entries in accordance with various embodiments of the present invention;

FIG. 10 is a configuration for a split screen eBOL with consignee entries filled in in accordance with various embodiments of the present invention;

FIG. 11 is an eBOL displaying stakeholder's entries in accordance with various embodiments of the present invention.

### DETAILED DESCRIPTION OF SOME EXAMPLE EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### I. Computer Program Products, Systems, Methods, and Computing Entities

Embodiments of the present invention may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of a data structure, apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

a. Exemplary System Architecture

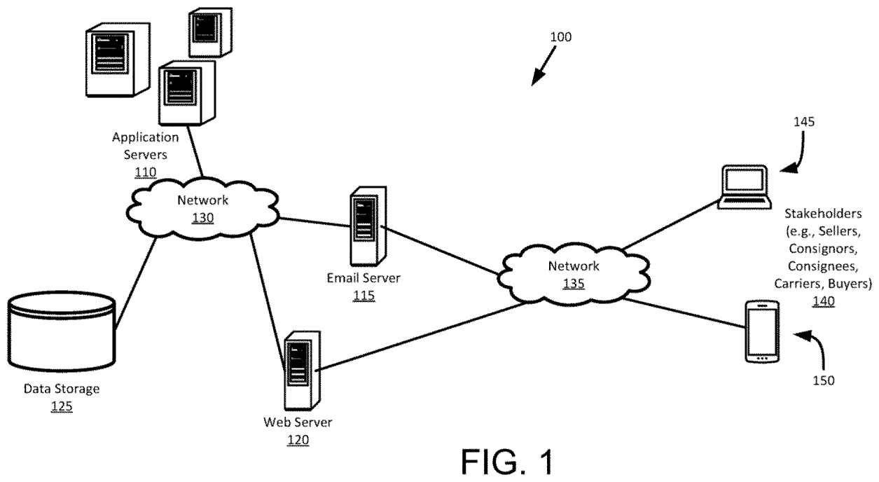

FIG. 1 provides an illustration of a system architecture 100 that may be used in accordance with various embodiments of the invention. Here, the architecture 100 includes various components for generating and managing electronic BOLs (eBOLs) that can be delivered and used by various stakeholders involved in a shipping process for goods. The components may be maintained and/or managed by a single entity or by multiple entities. For instance, in particular embodiments, a carrier used in transporting goods from one location to another may maintain and manage these components.

Accordingly, the components may include an email server 115 configured to send emails to various stakeholders (e.g., sellers, consignors, consignees, carriers, and buyers) 140 containing links. In various embodiments, these links allow for the stakeholders 140 to access eBOLs through a website hosted by a Web server 120. Depending on the embodiment, the Web server 120 may run any variety of server or mid-tier applications, including Hypertext Transfer Protocol (“HTTP”) servers, File Transfer Protocol (“FTP”) servers, Computer-Generated Imagery (“CGI”) servers, data servers, and Java servers. Here, the server 120 may be capable of executing programs and/or scripts in response to requests, such as executing one or more Web applications that may be implemented as one or more scripts and/or programs written in an appropriate programing language such as, for example, Java, C, C #, or C++, or scripting language such as, for example, Perl, Python, or TCL.

The components may also include one or more application servers 110 and one or more data storage 125. Accordingly, it should be understood that the application server(s) 110 and data storage 125 may be made up of several servers, storage media, layers, and/or other components, which may be chained or otherwise configured to interact and/or perform tasks. Specifically, the application server(s) 110 may include any appropriate hardware and/or software for interacting with the Web server 120 and/or the data storage 125 as needed to execute aspects of one or more applications for generating and managing eBOLs and handling data access and business logic for such. Furthermore, the data storage 125 may be a device or any combination of devices capable of storing, accessing, and retrieving data. For instance, depending on the embodiment, the data storage 125 may comprise any combination and number of data servers and data storage media in any standard, distributed, or clustered configuration. In various embodiments, the application server(s) 110 provide access control services in cooperation with the data storage 125 and are configured to generate content such as webpages that is transferred to a stakeholder 140 via the Web server 120 in an appropriate structured language such as Hypertext Markup Language (“HTML”) and/or eXtensible Markup Language (“XML”).

In particular embodiments, a stakeholder 140 may communicate with the Web server 120 over a HTTP or a Hypertext Transfer Protocol Secure (“HTTPS”) connection by selecting a hyperlink contained within an email. Here, the stakeholder 140 receives the email with the link to an eBOL for a particular shipment of goods and selects the link to access the eBOL through a website hosted by the Web server 120. Accordingly, the stakeholder 140 can then provide required information for the eBOL, as well as perform additional functionality such as download and/or print the eBOL.

The application server(s) 110, email server 115, Web server 120, and data storage 125 communicate with one another over one or more networks 130. Likewise, the email server 115 and Web server 120 communicate with one or more devices 145, 150 being used by the stakeholders 140 over one or more networks 135. For example, these devices 145, 150 may be a computing device 145 such as a desktop or laptop computer or a mobile device 150 such as a smart phone or tablet. Depending on the embodiment, these networks 130, 135 may comprise any type of known network such as a land area network (LAN), wireless land area network (WLAN), wide area network (WAN), metropolitan area network (MAN), wireless communication network, the Internet, etc., or combination thereof. In addition, these networks 130, 135 may comprise any combination of standard communication technologies and protocols. For example, communications may be carried over the networks 130, 135 by link technologies such as Ethernet, 802.11, CDMA, 3G, 4G, or digital subscriber line (DSL). Further, the networks 130, 135 may support a plurality of networking protocols, including the hypertext transfer protocol (HTTP), the transmission control protocol/internet protocol (TCP/IP), or the file transfer protocol (FTP), and the data transferred over the networks 130, 135 may be encrypted using technologies such as, for example, transport layer security (TLS), secure sockets layer (SSL), and internet protocol security (IPsec). Those skilled in art will recognize FIG. 1 represents but one possible configuration of a system architecture 100, and that variations are possible with respect to the protocols, facilities, components, technologies, and equipment used.

b. Exemplary Computing Entity

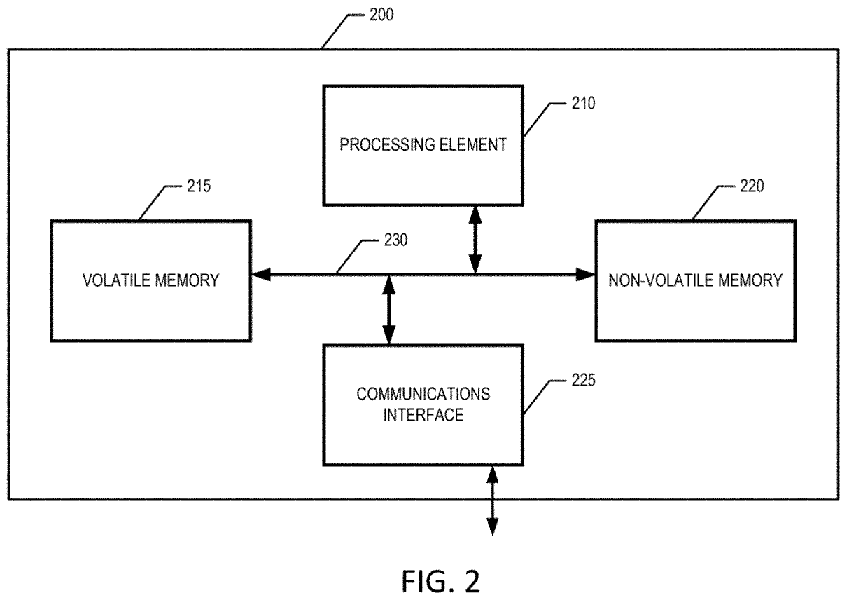

FIG. 2 provides a schematic of a computing entity 200 according to various embodiments of the present invention. For instance, the computing entity 200 may be an application server 110, email server 115, and/or Web server 120 found within the system architecture 100 previously described in FIG. 1. In general, the terms computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

Although illustrated as a single computing entity, those of ordinary skill in the art should appreciate that the computing entity 200 shown in FIG. 2 may be embodied as a plurality of computing entities, tools, and/or the like operating collectively to perform one or more processes, methods, and/or steps. As just one non-limiting example, the computing entity 200 may comprise a plurality of individual data tools, each of which may perform specified tasks and/or processes.

Depending on the embodiment, the computing entity 200 may include one or more network and/or communications interfaces 225 for communicating with various computing entities, such as by communicating data, content, information, and/or similar terms used herein interchangeably that can be transmitted, received, operated on, processed, displayed, stored, and/or the like. For instance, the computing entity 200 may communicate with other computing entities such as one or more devices 145, 150 being used by stakeholders 140 and/or the like. Thus, in certain embodiments, the computing entity 200 may be configured to receive data from one or more data sources and/or devices as well as receive data indicative of stakeholder input, for example, from a device.

As already mentioned, the networks used for communicating may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks may have any suitable communication range associated therewith and may include, for example, global networks (e.g., the Internet), MANs, WANs, LANs, or PANs. In addition, the networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Accordingly, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 200 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

In addition, in various embodiments, the computing entity 200 includes or is in communication with one or more processing elements 210 (also referred to as processors, processing circuitry, and/or similar terms used herein interchangeably) that communicate with other elements within the computing entity 200 via a bus 230, for example, or network connection. As will be understood, the processing element 210 may be embodied in several different ways. For example, the processing element 210 may be embodied as one or more complex programmable logic devices (CPLDs), microprocessors, multi-core processors, coprocessing entities, application-specific instruction-set processors (ASIPs), and/or controllers. Further, the processing element 210 may be embodied as one or more other processing devices or circuitry. The term circuitry may refer to an entirely hardware embodiment or a combination of hardware and computer program products. Thus, the processing element 210 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 210 may be configured for a particular use or configured to execute instructions stored in volatile or non-volatile media or otherwise accessible to the processing element 210. As such, whether configured by hardware, computer program products, or a combination thereof, the processing element 210 may be capable of performing steps or operations according to embodiments of the present invention when configured accordingly.

In various embodiments, the computing entity 200 may include or be in communication with non-volatile media (also referred to as non-volatile storage, memory, memory storage, memory circuitry and/or similar terms used herein interchangeably). For instance, the non-volatile storage or memory may include one or more non-volatile storage or memory media 220 such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media 220 may store files, databases, database instances, database management system entities, images, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

In particular embodiments, the memory media 220 may also be embodied as a data storage device or devices, as a separate database server or servers, or as a combination of data storage devices and separate database servers. Further, in some embodiments, the memory media 220 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. As already discussed, various embodiments contemplated herein data storage 125 in which some or all the information/data required for the eBOLs may be stored.

In various embodiments, the computing entity 200 may further include or be in communication with volatile media (also referred to as volatile storage, memory, memory storage, memory circuitry and/or similar terms used herein interchangeably). For instance, the volatile storage or memory may also include one or more volatile storage or memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media 215 may be used to store at least portions of the databases, database instances, database management system entities, data, images, applications, programs, program modules, scripts, source code, object code, byte code, compiled code, interpreted code, machine code, executable instructions, and/or the like being executed by, for example, the processing element 210. Thus, the databases, database instances, database management system entities, data, images, applications, programs, program modules, scripts, source code, object code, byte code, compiled code, interpreted code, machine code, executable instructions, and/or the like may be used to control certain aspects of the operation of the computing entity 200 with the assistance of the processing element 210 and operating system.

As will be appreciated, one or more of the computing entity's components may be located remotely from other computing entity components, such as in a distributed system. Furthermore, one or more of the components may be aggregated and additional components performing functions described herein may be included in the computing entity 200. Thus, the computing entity 200 can be adapted to accommodate a variety of needs and circumstances.

### II. Exemplary System Operation

The logical operations described herein may be implemented (1) as a sequence of computer implemented acts or one or more program nodules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. Greater or fewer operations may be performed than shown in the figures and described herein. These operations may also be performed in a different order than those described herein.

a. Display eBOL Module

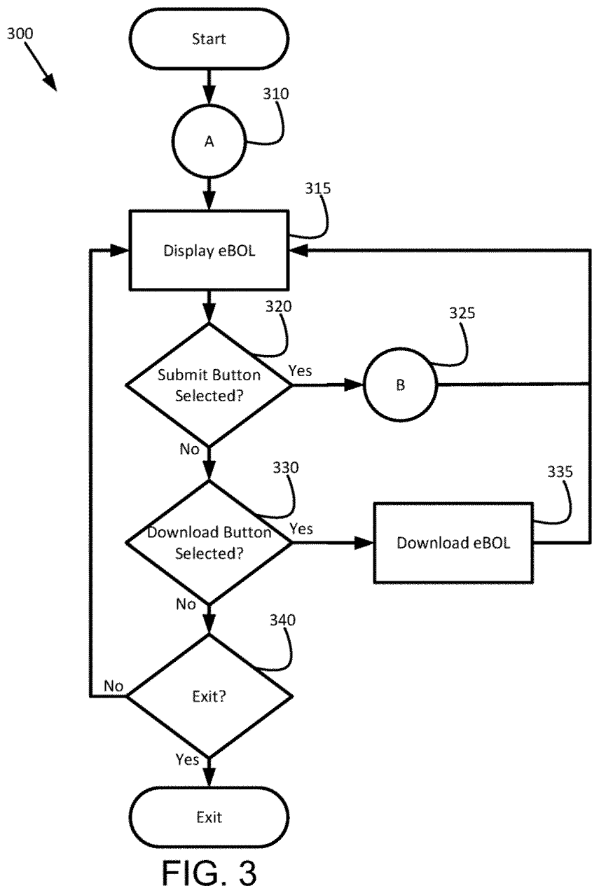

Turning now to FIG. 3, additional details are provided regarding a process flow for displaying an eBOL on a webpage, browser, interface according to various embodiments. Here, FIG. 3 is a flow diagram showing a display eBOL (DEBOL) module for performing such functionality according to various embodiments of the invention. For example, the flow diagram shown in FIG. 3 may correspond to operations carried out by a processor element 210 in a computing entity 200, such as the Web server 120 described in FIG. 1, as it executes the DEBOL module stored in the computing entity's volatile and/or nonvolatile memory.

In various embodiments, the DEBOL module is invoked as a result of a stakeholder 140 activating a hyperlink provided in an email received by the stakeholder 140. For instance, an email may have been delivered to a shipper prior to a time at which a shipment of goods is scheduled to be picked up by a carrier. For example, the email may have been delivered to the shipper (consignor) twenty-four hours prior to the scheduled pickup of the goods by the carrier. Accordingly, the email may contain a hyperlink that can be used by the shipper to access an eBOL for the shipment of the goods. Here, the shipper activates the link in the email at the appropriate time (e.g., when the carrier has arrived to pick up the goods), and a webpage, browser, interface is launched on a device 145, 150 being used by shipper to gain access to the eBOL.

In particular embodiments, the hyperlink provided in the email is unique with respect to the particular stakeholder 140 who receives the email. For example, the hyperlink may be unique with respect to the seller, shipper, carrier, and buyer involved in a shipment of goods. As discussed in further detail herein, such a configuration allows for the content provided on the eBOL displayed on the webpage, browser, interface to a stakeholder 140 to be customized for that particular stakeholder 140. In addition, the unique hyperlinks allow for the identification of the specific stakeholder 140 who is requesting access of the eBOL via the webpage, browser, interface. In particular embodiments, this may eliminate the need for usernames and passwords for the various stakeholders 140.

Further, in particular embodiments, the hyperlink may only be activated based at least in part on a particular event and/or during a particular period of time. For example, the link may only be activated once the carrier has arrived at the consignor's facility to pick up the goods and has indicated such by sending an email and/or the link may only be activated within a window of time with respect to the scheduled pick up time for the goods. Those of ordinary skill in the art can envision other mechanisms that may be utilized for activating the link in light of this disclosure.

Therefore, the process flow 300 shown in FIG. 3 begins in various embodiments with the DEBOL module generating the eBOL in Operation 310. Here, in particular embodiments, the DEBOL module performs this particular operation by invoking a generate eBOL (GEBOL) module. In turn, the GEBOL module generates the eBOL, to display to the stakeholder 140 on the webpage, browser, interface.

Accordingly, the DEBOL module displays the eBOL on the webpage, browser, interface in Operation 315. Here, depending on the embodiment, the DEBOL nodule may receive the eBOL from the GEBOL module directly or may access the eBOL from some type of data storage 125. At this point, the stakeholder 140 can then view the eBOL on the webpage, browser, interface. For instance, in particular embodiments, the eBOL is displayed as a split screen with an interactive panel displayed on one half of the webpage, browser, interface and a display panel providing a formal version of the eBOL displayed on the other half of the webpage, browser, interface. In these particular embodiments, the interactive panel of the eBOL provides a number of different fields in which the stakeholder 140 can enter needed information for the eBOL. For example, the interactive panel may provide signature and date fields so that the stakeholder 140 can sign and date the eBOL.

Thus, in particular embodiments, the stakeholder 140 may enter needed information for the eBOL on the interactive panel and select a submit button. In turn, the DEBOL module determines whether the stakeholder 140 has selected the submit button in Operation 320. If so, then the module records the entered information for the eBOL in Operation 325. Here, the DEBOL module may perform this particular operation by invoking a record eBOL information (REBOL) module and the REBOL module records the information entered by the stakeholder 140 in some type of data storage 125. As a result, any stakeholder 140 who subsequently views the eBOL will see the entered information displayed on the eBOL. That is to say, the eBOL displays the most up-to-date information for the eBOL as information is provided and submitted by stakeholders 140.

In various embodiments, the eBOL may provide stakeholders 140 with functionality to perform desired tasks. For instance, the eBOL may provide the stakeholder 140 with a capability (e.g., download button) to download the formal version of the eBOL with the information filled in by stakeholders 140. Thus, the DEBOL module determines whether the stakeholder 140 has selected the download button in Operation 330. If so, then the module downloads the formal version of the eBOL for the stakeholder 140 in Operation 335. For instance, in particular embodiments, the DEBOL module downloads a pdf of the eBOL with the information entered and submitted by stakeholders 140 displayed on the pdf. Accordingly, other functionality may be provided. For example, a print option may be provided so that a stakeholder 140 can print the formal version of the eBOL with the entered information. Those of ordinary skill in the art can envision other functionality that may be provided to stakeholders 140 in light of this disclosure.

At some point, the stakeholder 140 may be finished with viewing, entering information, downloading, printing, etc. for the eBOL and decide to exit the webpage, browser, interface by closing his or her browser. Therefore, in various embodiments, the DEBOL module determines whether the stakeholder 140 has exited the webpage, browser, interface in Operation 340. If not, then the module continues to display the eBOL on the webpage, browser, interface in Operation 315. However, if the stakeholder 140 has exited, then the process flow 300 ends and the DEBOL module exits.

b. Generate eBOL Module

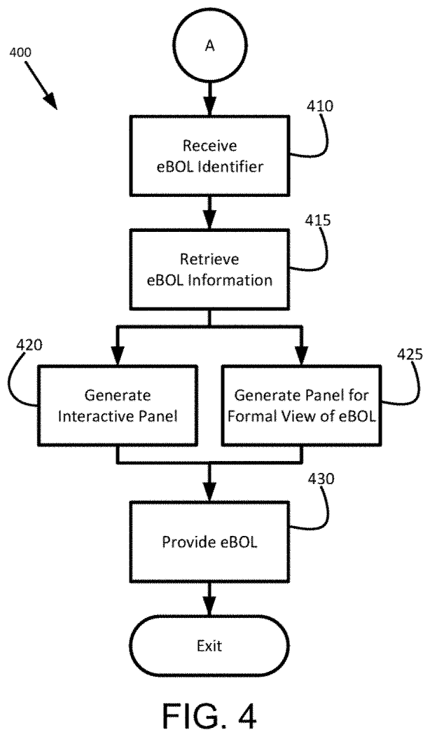

Turning now to FIG. 4, additional details are provided regarding a process flow for generating an eBOL according to various embodiments. Here, FIG. 4 is a flow diagram showing a generate eBOL (GEBOL) module for performing such functionality according to various embodiments of the invention. For example, the flow diagram shown in FIG. 4 may correspond to operations carried out by a processor element 210 in a computing entity 200, such as an application server 110 described in FIG. 1, as it executes the GEBOL module stored in the computing entity's volatile and/or nonvolatile memory.

As previously mentioned, the GEBOL module may be invoked by another module in various embodiments to generate an eBOL. For instance, in particular embodiments, the GEBOL module may be invoked by the DEBOL module as previously described to generate an eBOL related to a hyperlink provided in an email and activated by a stakeholder 140. However, with that said, the GEBOL may not necessarily be invoked by another module and may execute as a stand-alone module in other embodiments.

The process flow 400 begins with the GEBOL module receiving an identifier for a particular eBOL in Operation 415. For instance, an email with a hyperlink may be delivered to a shipper prior to a time when a shipment of goods is scheduled to be picked up by a carrier. Here, the shipper may activate the link in the email at an appropriate time (e.g., when the carrier arrives to pick up the goods) and a webpage, browser, interface is launched on a device 145, 150 being used by shipper to gain access to the eBOL for the shipment of goods. As a result, the DEBOL module previously discussed may invoke the GEBOL module to generate the eBOL and provide the identifier for the eBOL accordingly.

In turn, the GEBOL module retrieves the information for the eBOL in Operation 415. Here, depending on the embodiment, the information may be retrieved from one or more data storage 125. For instance, the data storage 125 may host one or more databases that stores the information for various eBOLs, and the identifier may be used by the GEBOL module in querying the appropriate information for the eBOL from the database.

Once the GEBOL module retrieves the information for the eBOL, the module generates the components for the eBOL to display on the webpage, browser, interface. Specifically, in particular embodiments, the GEBOL module generates an interactive panel for the eBOL in Operation 420. Here, the interactive panel provides a number of different fields in which the stakeholder 140 can provide needed information for the eBOL. For example, the interactive panel may provide signature and date fields so that the stakeholder 140 can sign and date the eBOL. In particular instances, some of these fields may be specific with respect to the stakeholder 140 requesting the eBOL. Accordingly, the identifier provided to the GEBOL module may also identify which of the stakeholders 140 is requesting the eBOL. For example, if the stakeholder 140 is a shipper, a field may be provided that allows the shipper to identify whether the shipper or carrier loaded the goods for a shipment into a trailer.

In addition, the GEBOL module in particular embodiments also generates a panel providing a formal version of the eBOL in Operation 425. For instance, as already discussed, the GEBOL generates a pdf of the eBOL to display on the webpage, browser, interface. Here, the formal version of the eBOL may be configured so that as the stakeholder 140 enters and submits information on the interactive form, the formal version of the eBOL is updated accordingly with the information.

Finally, the GEBOL module provides the web server 120 with the eBOL to display in Operation 430. Depending on the embodiment, the GEBOL module may provide the eBOL directly to another module, such as the DEBOL module, to display or the GEBOL module may save the eBOL in some type of data storage 125 so that it can be accessed and displayed on the webpage, browser, interface.

c. Record eBOL Information Module

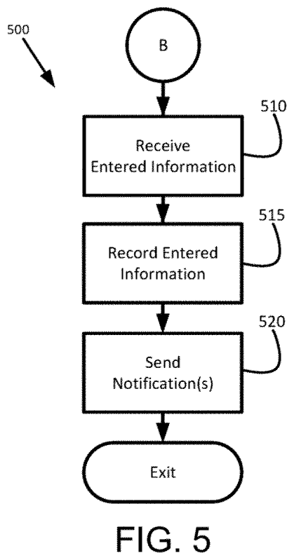

Turning now to FIG. 5, additional details are provided regarding a process flow for recording information entered by a stakeholder 140 for an eBOL according to various embodiments. Accordingly, FIG. 5 is a flow diagram showing a record eBOL information (REBOL) module for performing such functionality according to various embodiments of the invention. For example, the flow diagram shown in FIG. 5 may correspond to operations carried out by a processor element 210 in a computing entity 200, such as an application server 110 described in FIG. 1, as it executes the REBOL module stored in the computing entity s volatile and/or nonvolatile memory.

As previously mentioned, the REBOL module may be invoked by another module in various embodiments to record information entered by a stakeholder 140 on an eBOL. For instance, in particular embodiments, the REBOL module may be invoked by the DEBOL module described herein to record the information for the eBOL. However, that may not always be the case and instead the REBOL may executed as a stand-alone module in other embodiments.

The process flow 500 begins in various embodiments with the REBOL module receiving the information for the eBOL in Operation 510. Here, in particular embodiments, the information may be passed to the REBOL module by another module such as the DEBOL module or the REBOL module may retrieve the information directly from a source such as the interactive panel on the webpage for the eBOL.

Once the REBOL module has received the information, the module records the information for the eBOL in some type of data storage 125 in Operation 515. Accordingly, as result of recording the information in a centralized located, any subsequent retrieval of the eBOL will displayed the recorded information. For instance, a shipper may access and display an eBOL for a particular shipment of goods that is to be handled by a particular carrier. Here, the carrier may arrive at the shipper's facility to pick up the goods for transport and as a result, the shipper may sign and date the eBOL using the interactive panel displayed for the eBOL to confirm the shipper's handing over of the goods to the carrier. Thereafter, the carrier (the driver for the carrier) may then access and display the eBOL for the shipment of goods so that he or she may also sign and date the eBOL to acknowledge receipt of the goods. Since the information entered by the shipper was previously recorded and then used in generating the eBOL displayed to the carrier, the eBOL displayed to the carrier now shows the shipper's signature and date.

Not only subsequent views of an eBOL may display the information entered by a stakeholder 140, but current views of an eBOL in particular embodiments may also display the information entered by a stakeholder 140. For instance, returning to the example, the driver for the carrier may have accessed the eBOL prior to the shipper signing and dating the eBOL. However, in these particular embodiments, the carrier's view of the eBOL may be updated in real time upon the shipper entering his or her signature and date to display such. Here, the webpage, browser, interface may be configured to query the information for the eBOL at a set interval of time (e.g., every ten seconds) to ensure the most up-to-date information is displayed on the eBOL. While in other instances, any newly entered information for an eBOL may be pushed out if the eBOL is currently being displayed on a webpage, browser, interface.

Finally, the REBOL module sends any required notifications for the eBOL in Operation 520. Here, in particular embodiments, the REBOL module may be configured to send notifications to particular stakeholders' personal devices 145, 150 when information has been recorded for an eBOL. For instance, returning to the example above, the REBOL module may be configured to send an email with a hyperlink to the eBOL to the carrier once the eBOL has been signed and dated by the shipper. In addition, the REBOL module may be configured to send an email to other stakeholders 140 such as the receiver (e.g., consignee) of the goods. In this way, the eBOL for the shipment of the goods is delivered to the various stakeholders 140 throughout the shipping process at appropriate steps so that the eBOL can be timely filled out by the stakeholders 140. Furthermore, having the REBOL module send such notifications to stakeholders' personal devices 145, 150 in various embodiments facilitates the distribution of the eBOL for the shipment without having to pass along a single physical copy of the BOL or use a single physical device to display an electronic version of the BOL to be filled out by the various stakeholders 140. That is to say, various embodiments of the invention facilitate the use of BOLs within the shipping process without the need to have multiple parties (stakeholders 140 in the shipping process) touch a common instrument such as a physical copy of the BOLs or a physical device to display the BOLs.

### III. Exemplary Embodiments of eBOLs

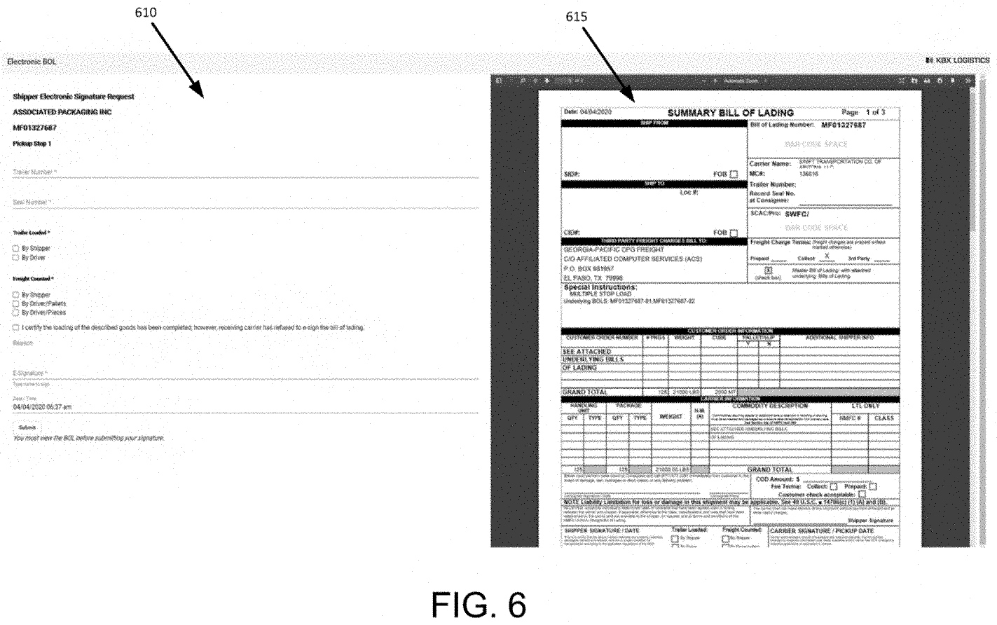

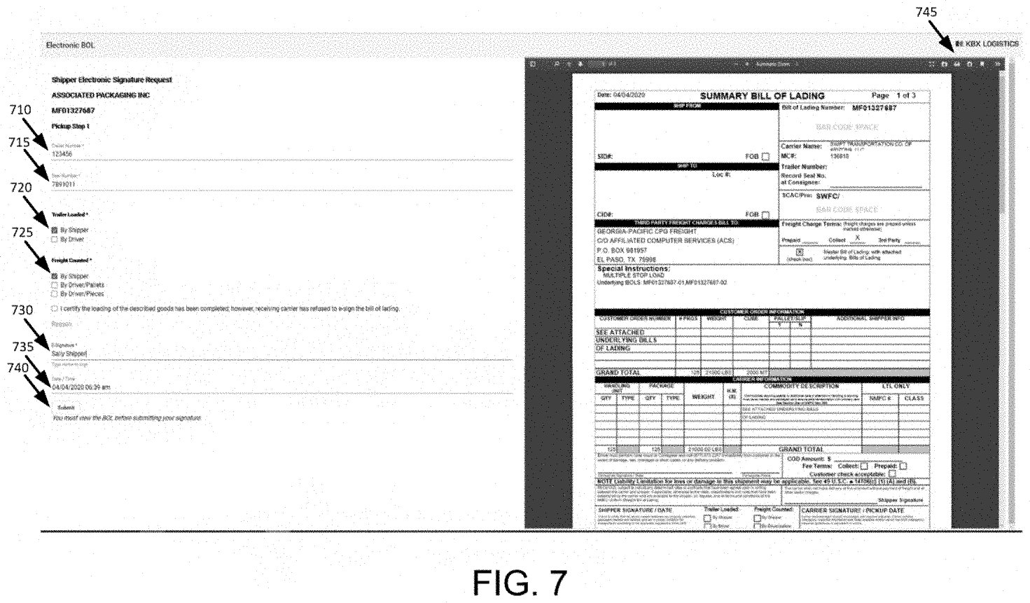

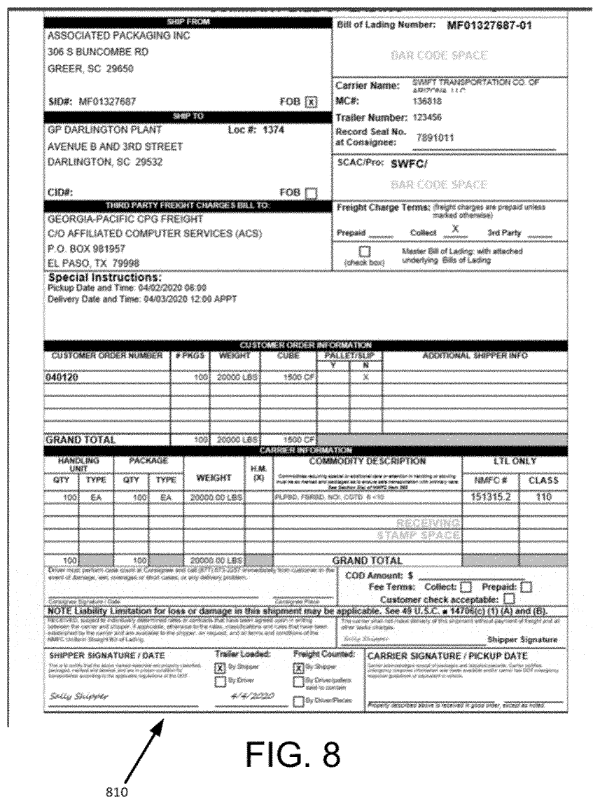

FIGS. 6 through 11 provide embodiments of eBOLs according to various embodiments. FIG. 6 displays a split screen configuration for an eBOL that may be displayed on a webpage, browser, interface. Here, an interactive panel 610 is shown on the left side of the configuration and a panel providing the formal version of the eBOL 615 is shown as a pdf on the right side of the configuration. The particular eBOL shown in FIG. 6 is for a shipper. Thus, turning to FIG. 7, the shipper is able to provide information such as the number of the trailer used by the carrier in shipping the goods 710, the seal number 715, whether the trailer was loaded by the shipper or driver 720, and whether the freight was counted by the shipper or driver 725. In addition, fields 730, 735 are provided so that the shipper can sign and date the eBOL. Further, a button 740 is provided so that the shipper can submit the entered information. Finally, controls 745 are provided on the display panel providing the formal version of the eBOL 615 to allow him or her to perform functionality such as download and/or print the eBOL. As shown in FIG. 8, the formal version of the eBOL 615 has been updated accordingly to reflect the information 810 entered by the shipper.

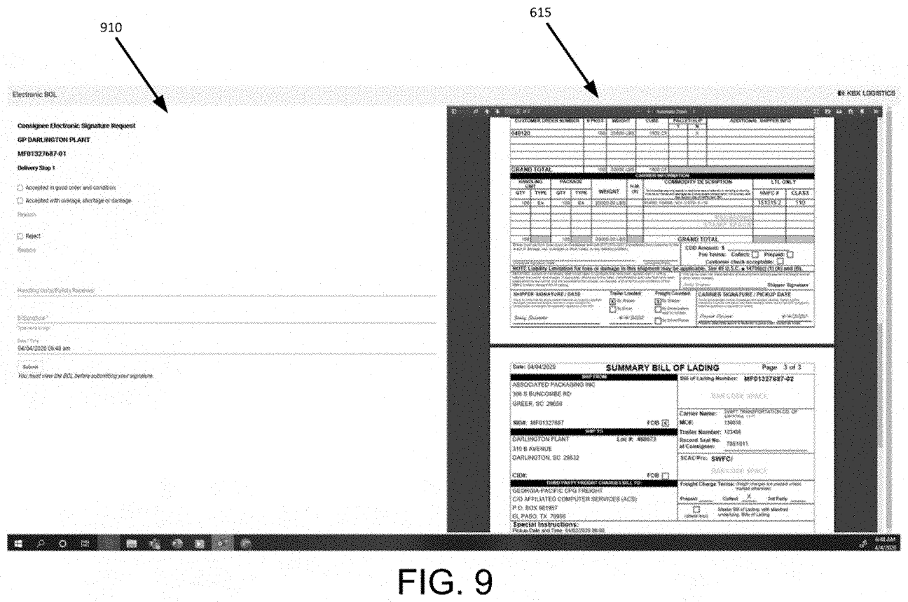

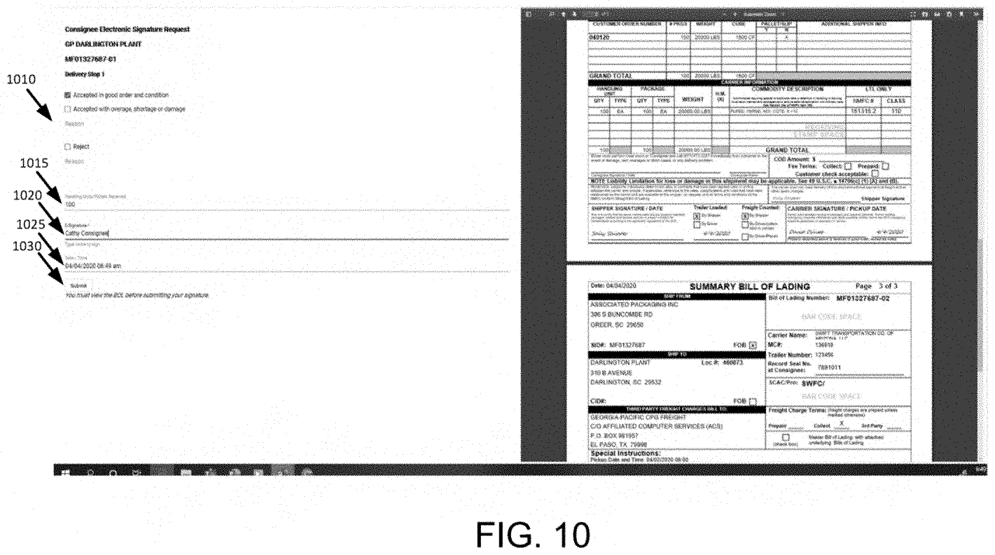

Turning now to FIG. 9, an eBOL is shown with the interactive panel 910 configured with fields for a consignee. Here, one can see the fields provided on the display panel 910 are different than the fields provided on the interactive panel 610 for a shipper while the display panel provided for the formal version of the eBOL 615 remains the same. As shown in FIG. 10, the interactive panel 910 for a consignee includes fields 1010 to either accept or reject the goods and provide a reason with respect to each. In addition, a field 1015 is provided to indicate the handling units received and fields 1020, 1025 are provided to sign and date the eBOL, along with a button 1030 to submit the entered information.

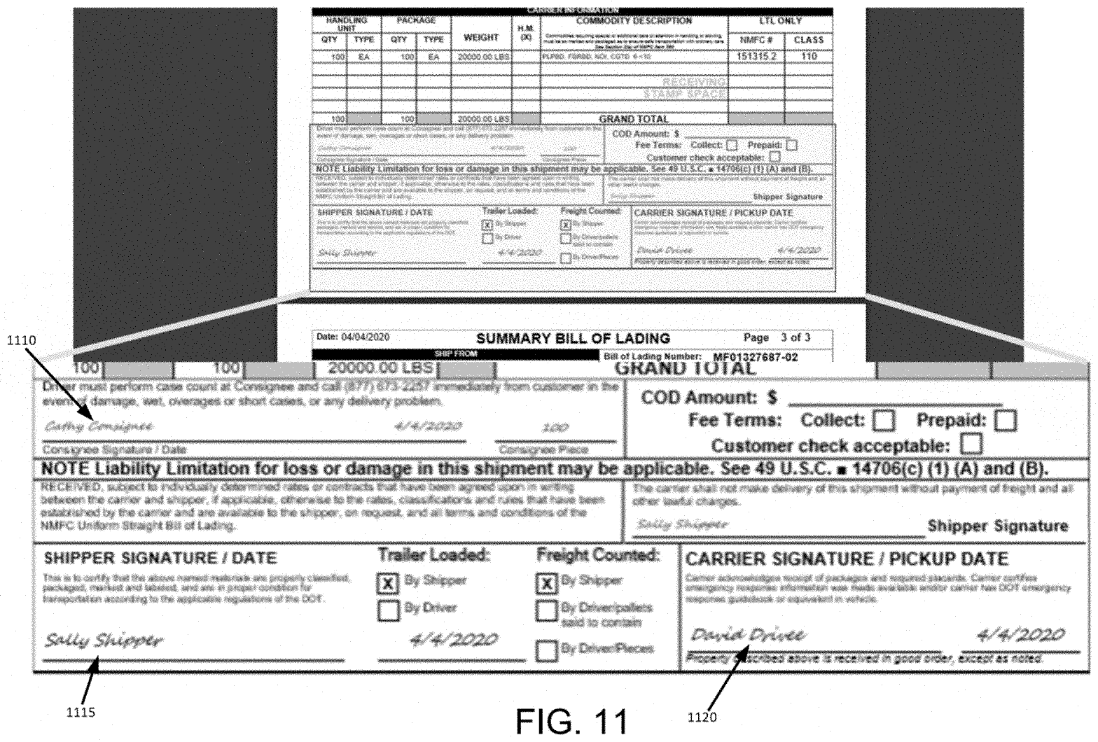

Finally, FIG. 11 displays a completed eBOL with the required information from the different stakeholders 140 involved in the shipping process. Here, the information entered by the consignee 1110, shipper 1115, and carrier 1120 are shown in the appropriate sections of the eBOL. Accordingly, in particular embodiments, each of these stakeholders 140 is provided with emails containing hyperlinks throughout the shipping process so that he or she can access the eBOL at different steps of the process to ensure the shipment of the goods is proceeding as planned, as well as to obtain the document (e.g., download and/or print) if needed.

Although other configurations of the eBOL are contemplated in addition to a split screen configuration, several technical advantages are realized in various embodiments by using a split screen configuration to display the eBOL. For instance, a split screen configuration facilitates focusing a viewer's attention on specific content of importance for the eBOL. Specifically, using a split screen to set off what information needs to be provided by a particular stakeholder 140 on the interactive panel 610, 910 of the eBOL highlights such information to the stakeholder 140. Therefore, the stakeholder 140 is not required to search through the eBOL to identify what information he or she is required to provide.

In addition, a split screen configuration allows for different elements to be offered without the need for substantial programming work. By splitting the information required by a stakeholder 140 and the formal version of the eBOL into different panels, different combinations of panels can be provided with minimal effort. For instance, the information provided by a shipper is not the same as the information provided by a consignee. Therefore, minimal programming is needed to display the appropriate interactive panels 610, 910 for the different stakeholders 140 along with the display panel providing the formal version of the eBOL 615. That is to say, the eBOL can be easily designed using a shipper interactive panel 610 along with the display panel providing the formal version of the eBOL 615 in a first instance and designed using a consignee interactive panel 910 along with the display panel providing the formal version of the eBOL 615 in a second instance.

Further, a split screen configuration allows for individual control for different components of the eBOL and the ability to provide individual navigational elements for these components. Here, the interactive panel 610, 910 allows for control over what information can be provided by a particular stakeholder 140. While the display panel providing the formal version of the eBOL 615, 915 allows for elements to be provided to perform functionality such as downloading and/or printing the eBOL.

Finally, the split screen configuration allows for a common experience for viewing and interacting with eBOLs on different devices. That is to say, a split screen configuration allows for adaptation to different size screens. For instance, the embodiment of the eBOL shown in FIGS. 6 and 9 is a side-by-side layout that typically would be used for a desktop device 145, with the interactive panel 610, 910 of the eBOL displayed on the left side of the desktop screen and the display panel providing the formal version of the eBOL 615 displayed on the right side of the desktop screen. However, displaying the eBOL in such a layout may not be practical on all devices.

For example, a mobile device 150 typically has a screen that is longer in the vertical direction than in the horizontal direction. Therefore, the side-by-side layout of the eBOL shown in FIGS. 6 and 9 would not likely fit on a mobile device 150 in a manner that would be feasible for viewing and interacting with the eBOL on the device 150. However, the split screen configuration allows for the eBOL to be accommodated for a mobile device 150 in various embodiments. For instance, the eBOL may be adapted so that a stakeholder 140 is able to toggle between the interactive panel 610, 910 and the display panel providing the formal version of the eBOL (pdf) 615 on his or her mobile device 150 so that either can be viewed on the device 150 at any given time. In other words, a split screen configuration allows the panels to be stacked. Here, such a capability may be quite useful for a stakeholder 140 such as a driver working for a carrier, for example, who may be required to sign an eBOL on his or her mobile device 150 prior to leaving a shipping facility. Accordingly, a split screen configuration can allow for unconventional design solutions that offer unique experiences.

### IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for providing and managing an electronic bill of lading (eBOL) for a shipment of goods, the method comprising:
responsive to receiving a request originating from a stakeholder computing entity associated with the shipment of goods, generating, by one or more processors, the eBOL from information stored in centralized storage media, wherein (a) the eBOL is configured for display as a split screen of a webpage, (b) the split screen of the webpage comprises an interactive panel with a plurality of fields into which information can be input, (c) the split screen of the webpage comprises a display panel with a formal version of the eBOL in which the eBOL is displayed, and (d) the interactive panel and the display panel are non-overlapping panels of the webpage; and
responsive to receiving input into a field of the plurality of fields, updating the information stored in the centralized storage media to reflect the information entered by the stakeholder, wherein the display panel comprising the formal version of the eBOL is updated to display the input entered in the field of the plurality of fields.

2. The computer-implemented method of claim 1, wherein at least one of the plurality of fields is specific to the stakeholder.

3. The computer-implemented method of claim 1, wherein the request for the eBOL is generated as a result of the stakeholder computing entity activating a hyperlink provided in an email.

4. The computer-implemented method of claim 1 further comprising providing one or more notifications to one or more of the other stakeholder computing entities indicating that the eBOL has been updated.

5. The computer-implemented method of claim 1, wherein the display panel comprising the formal version of the eBOL further comprises control elements that allow the stakeholder computing entity to download and print the formal version of the eBOL.

6. An apparatus for providing and managing an electronic bill of lading (eBOL) for a shipment of goods, the apparatus comprising at least one processor and at least one memory including program code, the at least one memory and the program code configured to, with the processor, cause the apparatus to at least:
responsive to receiving a request originating from a stakeholder computing entity associated with the shipment of goods, generate the eBOL from information stored in centralized storage media, wherein (a) the eBOL is configured for display as a split screen of a webpage, (b) the split screen of the webpage comprises an interactive panel with a plurality of fields into which information can be input, (c) the split screen of the webpage comprises a display panel with a formal version of the eBOL in which the eBOL is displayed, and (d) the interactive panel and the display panel are non-overlapping panels of the webpage; and
responsive to receiving input into a field of the plurality of fields, update the information stored in the centralized storage media to reflect the information entered by the stakeholder, wherein the display panel comprising the formal version of the eBOL is updated to display the input entered in the field of the plurality of fields.

7. The apparatus of claim 6, wherein at least one of the plurality of fields is specific to the stakeholder.

8. The apparatus of claim 6, wherein the request for the eBOL is generated as a result of the stakeholder computing entity activating a hyperlink provided in an email.

9. The apparatus of claim 6, wherein the at least one memory and the program code are further configured to, with the processor, cause the apparatus to provide one or more notifications to one or more of the other stakeholder computing entities indicating that the eBOL has been updated.

10. The apparatus of claim 6, wherein the display panel comprising the formal version of the eBOL further comprises control elements that allow the stakeholder computing entity to download and print the formal version of the eBOL.

11. A computer program product for providing and managing an electronic bill of lading (eBOL) for a shipment of goods, the computer program product comprising at least one non-transitory computer-readable storage medium having computer-readable program code portions stored therein, the computer-readable program code portions comprising:
an executable portion configured to, responsive to receiving a request originating from a stakeholder computing entity associated with the shipment of goods, generate the eBOL from information stored in centralized storage media, wherein (a) the eBOL is configured for display as a split screen of a webpage, (b) the split screen of the webpage comprises an interactive panel with a plurality of fields into which information can be input, (c) the split screen of the webpage comprises a display panel with a formal version of the eBOL in which the eBOL is displayed, and (d) the interactive panel and the display panel are non-overlapping panels of the webpage; and
an executable portion configured to, responsive to receiving input into a field of the plurality of fields, update the information stored in the centralized storage media to reflect the information entered by the stakeholder, wherein the display panel comprising the formal version of the eBOL is updated to display the input entered in the field of the plurality of fields.

12. The computer program product of claim 11, wherein at least one of the plurality of fields is specific to the stakeholder.

13. The computer program product of claim 11, wherein the request for the eBOL is generated as a result of the stakeholder computing entity activating a hyperlink provided in an email.

14. The computer program product of claim 11, wherein the computer-readable program code portions further comprise an executable portion configured to provide one or more notifications to one or more of the other stakeholder computing entities indicating that the eBOL has been updated.

15. The computer program product of claim 11, wherein the display panel comprising the formal version of the eBOL further comprises control elements that allow the stakeholder computing entity to download and print the formal version of the eBOL.
